(19) United States
(12) Patent Application Publication
(10) Pub. No.: US 2007/0078895 A1
(43) Pub. Date: Apr. 5, 2007

(54) SYSTEM AND METHOD FOR GENERATING A PLAY-LIST

(76) Inventors: Kuan-Hong Hsieh, Shenzhen (CN); Zai-An Pan, Shenzhen (CN); Xiao-Guang Li, Shenzhen (CN); Bing Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,155

(22) Filed: Jun. 30, 2006

Related U.S. Application Data
(63) Continuation-in-part of application No. 11/308,697, filed on Apr. 24, 2006.
(63) Continuation-in-part of application No. 11/308,707, filed on Apr. 24, 2006.
(63) Continuation-in-part of application No. 11/308,708, filed on Apr. 24, 2006.
(63) Continuation-in-part of application No. 11/308,751, filed on Apr. 28, 2006.

(30) Foreign Application Priority Data
Jul. 13, 2005 (CN) 200510035984.8
Jun. 17, 2005 (CN) 200510035413.4
Jun. 24, 2005 (CN) 200510035542.3
Jun. 24, 2005 (CN) 200510035531.5
Jun. 24, 2005 (CN) 200510035533.4

(51) Int. Cl. G06F 7/00

(52) U.S. Cl. 707/104.1

(57) ABSTRACT

The present invention relates to a method for generating a play-list of media files, includes the steps of: rearranging the media files based on weight values in weight fields of each media file in descending order; resetting sub-category weight values associated with desired sub-category in category tables to zero; obtaining a predetermined amount of media files on the top of the ordered list; reading the desired sub-categories and the weight values in the category fields of the obtained media files; incrementing a corresponding sub-category weight value in the corresponding initialized category tables by the weight values of the obtained media files; calculating final weight values of each media file according to the category tables; and generating the play-list of the media files according to the final weight values thereof. The present invention also provides a system for generating the play-list that makes the play-list more suitable for the user's favors.

### CROSS-REFERENCES TO RELATED APPLICATION

This application is a continuation-in-part application of U.S. patent application Ser. No. 11/308,697 entitled “system and method for generating a play-list,” filed on Apr. 24, 2006, U.S. patent application Ser. No. 11/308,708 entitled “system and method for generating a play-list,” filed on Apr. 24, 2006, U.S. patent application Ser. No. 11/308,707 entitled “system and method for generating a play-list,” filed on Apr. 24, 2006 and U.S. patent application Ser. No. 11/308,751 entitled “system and method for generating a play-list,” filed on Apr. 28, 2006.

### TECHNICAL FIELD

The present invention relates to a system and method for generating a media play-list, especially to a system and method for generating a play-list according to adjusted weight values of the media files.

### DESCRIPTION OF RELATED ART

The continuous development of new digital technology has helped made digital devices such as digital audio, digital picture, and other digital medias become popular among people. Media can be stored digitally in various data storage medium such as a hard disk, a compact disc (CD), and a network server. These data storage medium can then be used with portable devices such as a personal digital assistant (PDA), a media player, and/or an electronic-book reader (e-book). A current standard CD can store up to 140 average sized MPEG layer three (MP3) media files, whereas a media player with a data storage medium of 10 Gigabytes can store up to 2000 MP3 files. The cost of data storage medium has continued to decrease, allowing the average person to more easily acquire more data storage capacity. Currently, a personal computer has a standard data storage capacity of 80 Gigabytes that can easily store up to 160,000 pieces of average sized MP3 files. As users continuously acquire their favorite media files, it is important that users can also quickly identify and select a desired media file from a humongous pool of stored files.

Most media players currently have an option to group and select media files by the media file's tag contents. Usually, the media file's title, artist, album, and genre identity are stored by the tags to allow media players to automatically search and categorize the files. A media file management program further allows users to select a combination of media files into a play-list file. The saved play-list is essentially a list of shortcuts (pointer to the directory path) of the media files stored within, and can be used by the media player instead of manually searching and selecting every desired media files each time the media player is executed. Each play-list can then be categorically stored by name. However, users are still required to remember the directory path where each play-list is stored. As a user creates more and more play-lists, remembering a desired play-list may not be easy, furthermore, skipping over an unwanted media file while playing a play-list still has to be done manually.

In order to solve the problems mentioned, there is a method available in the market in selecting favorite media files to generate a play-list. For example, U.S. Pat. No. 6,987,221 issued on Jan. 17, 2006 and entitled “AUTO PLAYLIST GENERATION WITH MULTIPLE SEED SONGS” provides a method for generating a play-list automatically. The method includes steps of: selecting one or more feed media files, the feed media files include desired media files and undesired media files; wherein the user can set a weight on each seed media file representing the importance level of each seed media file. Afterwards, the method compares each media file with each seed media file such that a media file can be analyzed and identified into a user defined preferred play-list. The play-list further allows manual edits by the user.

However, the above mentioned method requires manual inputs on the weight attributes on multiple seed files before the method can run comparison tests on each media files. These manual operations may be annoying and time consuming with no guarantee that the resulting selected media files would be tailored to a user's listening preferences.

Therefore, a heretofore unaddressed need exists in the industry to overcome the aforementioned deficiencies and inadequacies.

### SUMMARY

After the media player 10 generates weight values of each media file automatically, a listener also wishes to select a plurality of media files according to one or more particular types, such as a genre, an artist and so on. In order to solve said problems, the present invention provides a method and system for automatically generating final weight values of the media files according to the weight values and the desired sub-categories thereof, whereby generating a play-list. The present invention makes the play-list more suitable to the user's listening preferences.

The method for generating a play-list of media files, each of the media files includes a tag for holding a plurality of items thereupon. The method includes the steps of: setting a weight field in the tag for storing a weight value of the media file and a plurality of category fields each storing a plurality of desired sub-category corresponding to the media file; setting a plurality of category tables each storing a desired sub-category and its corresponding sub-category weight values; rearranging the media files based on the weight values in the weight fields of each media file in descending order; resetting sub-category weight values associated with the desired sub-category in the category tables to zero; obtaining a predetermined amount of media files on the top of the ordered list; reading desired sub-categories and weight values in the category fields of the obtained media files; incrementing a corresponding total sub-category weight value in the corresponding initialized category tables by the weight values of the obtained media files; calculating final weight values of each media file according to the category tables; and generating the play-list of the media files according to the final weight values thereof.

The system for generating a play-list of media files, each of the media files includes a tag for holding a plurality of items thereupon. The system includes a data storage unit, an input unit, a control unit and a file management unit. The data storage unit stores a plurality of media files and one or more category tables. The tag of each media file includes a weight field for storing a weight value of the media file, and one or more other desired fields in the tag each of which storing a desired sub-category. Each of the category table stores one or more desired sub-categories and corresponding sub-category weight values; the desired sub-categories belong to a same type. The input unit generates commands in response to operations of a user. The control unit identifies the commands and performs corresponding control commands. The control commands include a play-list generation control command. The file management unit, under the control of the control unit, rearranges the media files based on the weight values in the weight fields of each media file in descending order; resets sub-category weight values associated with the desired sub-category in the category tables to zero; obtains a predetermined amount of media files on the top of the ordered list; reads desired sub-categories and weight values in the category fields of the obtained media files; increments a corresponding sub-category weight value in the corresponding initialized category tables by the weight values of the obtained media files; calculates final weight values of each media file according to the category tables; and generates the play-list of the media files according to the final weight values thereof.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a schematic diagram of a user-interface of an media player such as a MP3 player in accordance with a preferred embodiment of the present invention;

FIG. 2 is a block diagram of a hardware infrastructure of the media player in FIG. 1;

FIG. 3 is a module diagram of a file management unit of the media player in FIG. 1;

FIG. 4 is a flowchart of a preferred method for generating a play-list in the media player in FIG. 2;

FIG. 5 is a flowchart of a preferred method for calculating sub-category weight values of desired sub-categories;

FIG. 6 is a flowchart of a preferred method for calculating final weight values of each media file in FIG. 4;

FIG. 7 is a schematic diagram representing a relationship between an artist and a sub-category weight value in a first category table; and

FIG. 8 is a schematic diagram representing a relationship between a genre and a sub-category weight value in a second category table.

### DETAILED DESCRIPTION OF A PREFERRED EMBODIMENT

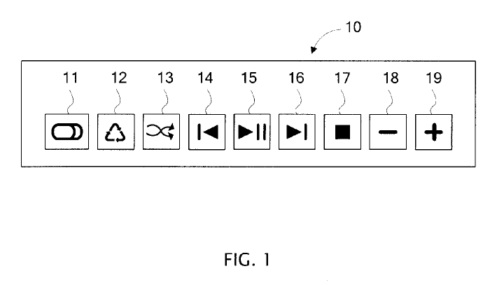

FIG. 1 is a schematic diagram of a user-interface of an media player such as a MP3 player in accordance with a preferred embodiment of the present invention. The media player 10 is user-controllable to skip forward (e.g., to next item), play a media file, pause a playing media file, skip backward (e.g., to previous item), activate/deactivate the media player, adjust the volume output of the media player, and the like. Accordingly, the media player 10 provides a user-interface for selecting these functions.

The user-interface sets a plurality of buttons thereon, such as a skip forward button 14, a play/pause button 15, a skip backward button 16, a stop/power button 17, a decrease volume button 18, and an increase volume button 19. The user-interface further sets a play in order button 12 for playing selected media files in a predefined sequential order, and a random play button 13 for playing the media files randomly. Moreover, the user-interface includes a locked button 11 for locking the buttons 12 to 19 thereby disabling the button functions therewith.

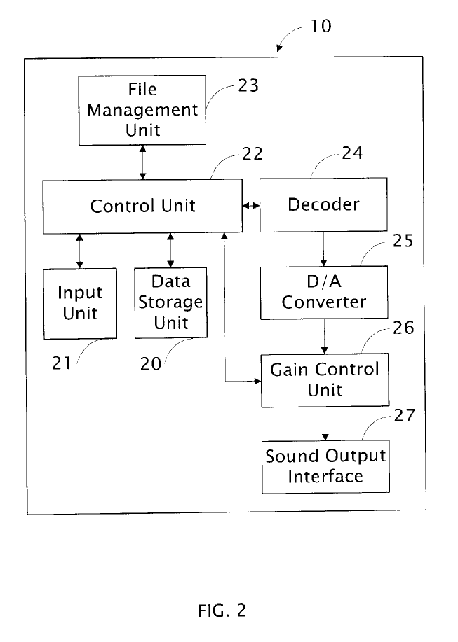

FIG. 2 is a block diagram of a hardware infrastructure of the media player 10 in FIG. 1. The media player 10 includes a data storage unit 20, an input unit 21, a file management unit 22, a control unit 23, a decoder 24, a digital/analog converter 25, a gain control unit 26, and a sound output interface 27. The data storage unit 20 stores a plurality of media files, one or more category tables, a default play-list, and one or more favorite index tables for indicating favorite media files of a user. Each of the media files is composed of a plurality of frames. Each frame can be viewed as a small segment of the media.

Furthermore, each media file includes a tag for holding a plurality of fields about the media file. The tag includes a weight field, an artist field, a genre field, etc., to store corresponding sub-categories such as a sub-category weight value, an artist, a genre, and so on. The sub-category weight value would indicate the user's preference level on a given media file. With respect to the category tables, for simplicity, in this embodiment, two category tables (i.e., a first category table and a second category table) are adopted as examples and described in detail below. Each category table is used for recording a desired sub-category and its corresponding sub-category weight values. For example, the first category table records the artists and their corresponding sub-category weight values, and the second category table records the genres and their corresponding sub-category weight values. In addition, the data storage unit 20 can be a flash storage, a hard disk driver, and the like.

The input unit 21 includes a plurality of buttons (i.e., 11 to 19), thereby forming the user-interface of a preferred media player (as shown in FIG. 1) to compute commands in response to operational inputs. The control unit 23 receives and identifies the commands from the input unit 21, and generates corresponding control commands to control the data storage unit 20, the file management unit 22, the gain control unit 26, and the like. The control commands include a control command for generating a play-list (namely a play-list generation control command).

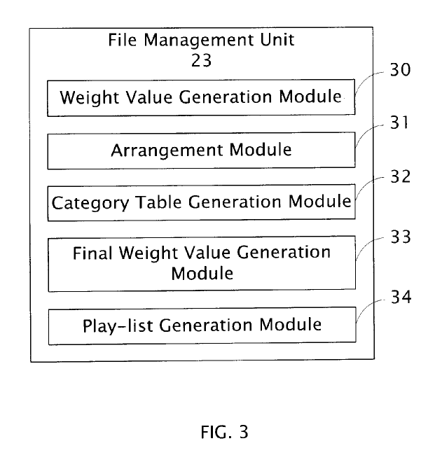

Referring to FIG. 3, the file management unit 23 includes a weight value generation module 30, an arrangement module 31, a category table generation module 32, a final weight value generation module 33 and a play-list generation module 34. In response to the play-list generation control command, the arrangement module 31 arranges the media files based on the weight values in weight fields of each media file in descending order thereby obtaining an ordered list, and the category table generation module 32 initializes the category tables (i.e., the first category table and the second category table). Accordingly, sub-category weight values associated with the artists and the genres in the category tables are reset to zero.

After the initialization, the category table generation module 32 further obtains a predetermined amount of media files on the top of the ordered list, reads the desired sub-categories (e.g., artists, genres) and weight values of the obtained media files, aggregating a corresponding sub-category (e.g., an artist or a genre) weight value in the corresponding initialized category tables by the weight values read from the obtained media files and then records the aggregated sub-category weight values in the corresponding initialized category tables. That is, the aggregated sub-category weight values associated with the artists are recorded in the first category table, whereas, the aggregated sub-category weight values associated with the genres are recorded in the second category table.

The final weight value generation module 33 calculates a final weight value of each media file according to the updated category tables, and stores the final weight values of each media file in a temporary file. For example, the final weight value generation module 33 assigns a weight value to each sub-category weight value in the updated category tables, obtains the sub-category weight values corresponding to the desired sub-categories each media file has from the updated category tables, multiplies each sub-category weight value by the corresponding weight value assigned therewith, and sums the multiplied sub-category weight values to obtain the final weight value of the media file. Alternatively, the final weight value generation module 33 directly aggregates the sub-category weight values of the desired sub-categories of a media file to obtain the final weight thereof.

The play-list generation module 34 generates the play-list of the media files according to the final weight values thereof in the temporary file, and stores the play-list in the data storage unit 20. The media files listed on the play-list may be from digital media files stored in the data storage unit 20, or may be from favorite digital media files indicated in the index table stored in the data storage unit 20. In addition, the weight value generation module 30 automatically generates weight values of each media file in the play-list as described in U.S. patent application Ser. No. 11/308,697 entitled “system and method for generating a play-list,” filed on Apr. 24, 2006, U.S. patent application Ser. No. 11/308,708 entitled “system and method for generating a play-list,” filed on Apr. 24, 2006, U.S. patent application Ser. No. 11/308,707 entitled “system and method for generating a play-list,” filed on Apr. 24, 2006, herein incorporated in its entirety by referenced and U.S. patent application Ser. No. 11/308,751 entitled “system and method for generating a play-list,” filed on Apr. 28, 2006.

The decoder 24 decodes the media file from a coded digital format into a readable digital format to be played. The digital/analog converter 25 converts the decoded digital media file to analog media signals. The gain control unit 26 amplifies the analog media signals under the control of the control unit 23. The sound output interface 27 outputs the amplified analog media signals to an earphone or a speaker (not shown).

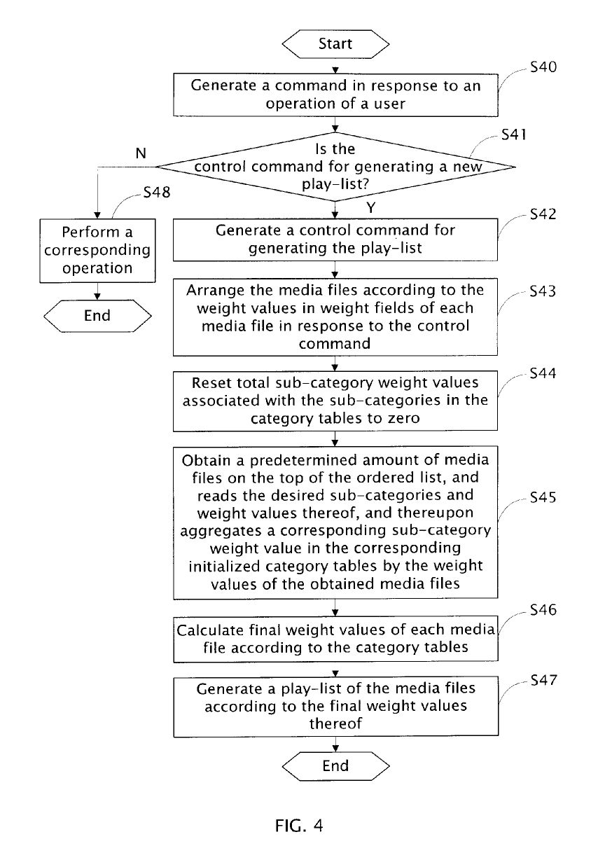

FIG. 4 is a flowchart of a preferred method for generating a play-list in the media player in FIG. 2. In a power-off state of the media player 10, a user selects the stop/power button 17 to activate the media player 10. In step S40, the input unit 21 generates a command in response to an input selection of the user, and sends the command to the control unit 23. In step S41, the control unit 23 determines whether an inputted command is for updating a default play-list, namely generating a new play-list. If the command is not for generating a play-list, in step S48, the control unit 23 generates a corresponding control command to control a corresponding unit to perform a corresponding operation, and the procedure is finished. If the command is for generating a play-list, in step S42, the file management unit 22 generates a control command to generating a play-list (namely a play-list generation control command).

In step S43, the file management unit 22 arranges the media files based on the weight values in weight fields of each media file in descending order, in response to the play-list generation control command. In step S44 the file management unit 22 resets sub-category weight values associated with the sub-categories in the category tables to zero. In step S45, the file management unit 22 obtains a predetermined amount of media files on the top of the ordered list, and reads the desired sub-categories (e.g., artists, genres) and weight values thereof, and thereupon aggregates a corresponding sub-category weight value in the corresponding initialized category tables by the weight values of the obtained media files.

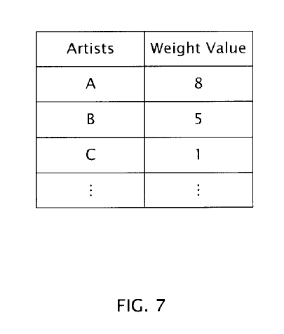

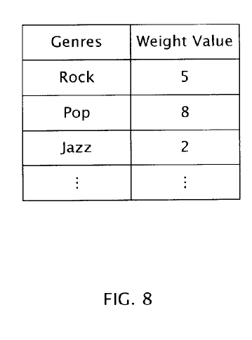

In step S46, referring to FIG. 7 and FIG. 8, the file management unit 22 calculates a final weight value of each media file according to the updated category tables, and stores the final weight values of each media file in a temporary file in the data storage unit 20.

In step S47, the file management unit 22 generates the play-list of the media files according to the final weight values thereof. For example, the file management unit 22 rearranges all the media files stored in the data storage unit 20 according to the final weight values, thereby generating a play-list therefrom. That is, the file management unit 22 orderly rearranges the media files according to the final weight values, or calls a random function, which employs the final weight values of the media files as a parameter, to randomly rearrange the media files. Therefore, the media files having the greater final weight values would be listed on more front of the play-list.

Furthermore, the file management unit 22 may also directly select a plurality of media files each of which has a final weight value being greater than a predetermined value, thereby generating another play-list therefrom. The file management unit 22 may also rearrange all the media files based on the final weight values in descending order, and then selects a predetermined amount of media files on the top of the ordered list, thereby generating another play-list therefrom.

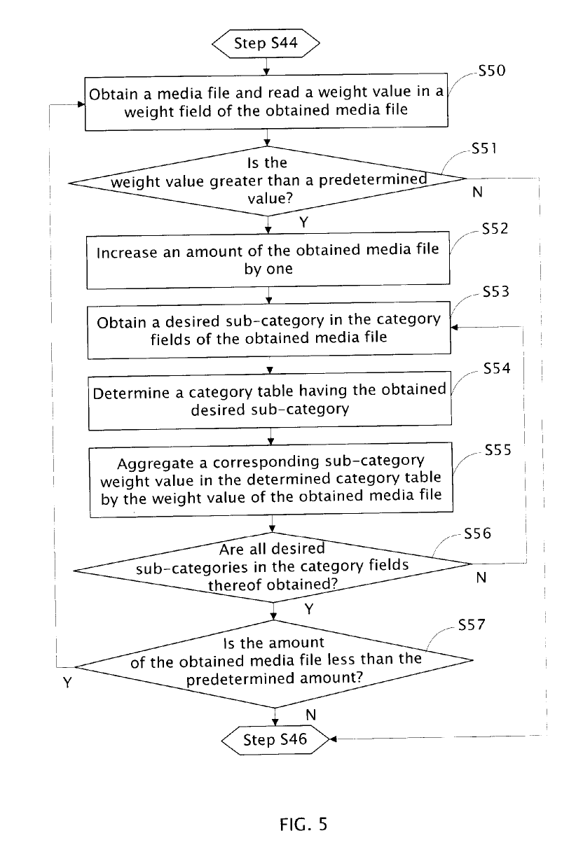

FIG. 5 is a flowchart of a preferred method for calculating sub-category weight values of desired sub-categories. In step S50, the file management unit 22 obtains a media file and reads a weight value in a weight field of the obtained media file. In step S51, the file management unit 22 determines whether the obtained weight value is greater than a predetermined value. If the obtained weight value is not greater than the predetermined value, the procedure goes to step S46. If the obtained weight value is greater than the predetermined value, in step S52, the file management unit 22 increases an amount of the obtained media file by one.

In step S53, the file management unit 22 obtains a desired sub-category (eg., an artist or a genre) in the category fields of the media file. In step S54, the file management unit 22 determines a category table having the obtained desired sub-category. In step S55, the file management unit 22 aggregates a corresponding sub-category weight value in the determined category table by the weight values of the obtained media files.

In step S56, the file management unit 22 determines whether all desired sub-categories in the category fields of the media file are obtained. If any desired sub-category in the category fields of the media file is not obtained, the procedure goes to step S53 to obtain a next desired sub-category in the category fields of the media file. If all desired sub-categories in the category fields of the media file are obtained, in step S57, the file management unit 22 determines whether the amount of the obtained media file is less than the predetermined amount. If the amount of the obtained media file is less than the predetermined amount, the procedure goes to step S50. If the amount of the obtained media file is not less than the predetermined amount, the procedure goes to step S46.

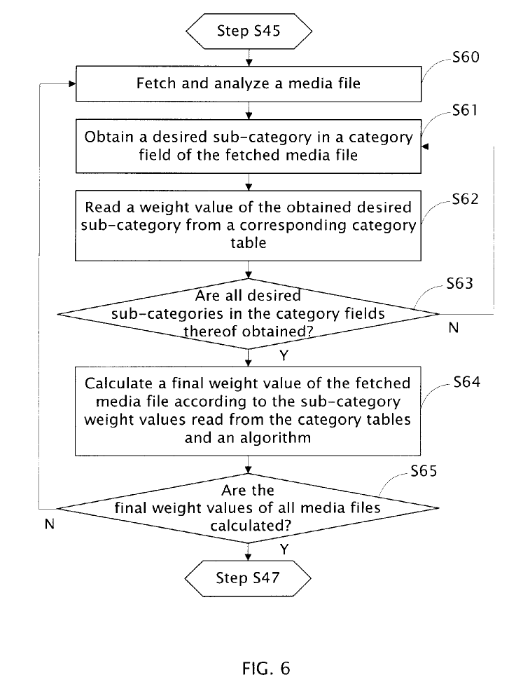

FIG. 6 is a flowchart of a preferred method for calculating final weight values of each media file in FIG. 4. In step S60, the file management unit 22 fetches and analyzes a media file. In step S61, the file management unit 22 obtains a desired sub-category in a category field of the fetched media file. In step S62, the file management unit 22 reads a sub-category weight value of the obtained desired sub-category from a corresponding category table.

In step S63, the file management unit 22 determines whether all desired sub-categories in the category fields of the media file are obtained. If any desired sub-category in the category fields of the media file is not obtained, the procedure goes to step S61. If all desired sub-categories in the category fields of the media file are obtained, in step S64, the file management unit 22 calculates a final weight value of the fetched media file according to the obtained sub-category weight values read from the category tables and an algorithm, and stores the final weight value in a temporary file.

In step S65, the file management unit 22 determines whether the final weight values of all media file are calculated. If the final weight value of any media file is not calculated, the procedure goes to step S60. If the final weight values of all the media files are calculated, the procedure goes to step S47.

FIG. 7 is a schematic diagram representing a relationship between an artist and a sub-category weight value in the first category table. For simplicity, in such case, the corresponding sub-category weight value of the artist A is 8; the corresponding sub-category weight value of the artist B is 5; the corresponding sub-category weight value of the artist C is 1. However, the relationship between the artist and sub-category weight value may vary. That is, the relationship between the artist and sub-category weight value can be set and adjusted.

FIG. 8 is a schematic diagram representing a relationship between a genre and a sub-category weight value in the second category table. For simplicity, in such case, the corresponding sub-category weight value of Rock is 5; the corresponding sub-category weight value of Pop is 8; the corresponding sub-category weight value of Jazz is 2. However, the relationship between the genre and sub-category weight value may vary. That is, the relationship between the genre and sub-category weight value can be set and adjusted.

It should be emphasized that the above-described embodiments, including preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. A method for generating a play-list of media files, each of the media files comprising a tag for holding a plurality of fields thereupon, the method comprising the steps of:
setting a weight field in the tag for storing a weight value of the media file and a plurality of category fields each storing a plurality of desired sub-categories corresponding to the media file;
setting a plurality of category tables each storing a desired sub-category and corresponding sub-category weight values;
rearranging the media files based on the weight values in the weight fields of each media file in descending order;
resetting sub-category weight values associated with the desired sub-category in the category tables to a predetermined initial value;
obtaining a predetermined amount of media files on the top of the ordered list;
reading desired sub-categories and weight values in the category fields of the obtained media files;
incrementing a corresponding sub-category weight value in the corresponding initialized category tables by the weight values of the obtained media files;
calculating final weight values of each media file according to the category tables; and
generating the play-list of the media files according to the final weight values thereof.

2. The method for generating a play-list according to claim 1, wherein the step of calculating a final weight value of the media file further comprises:
obtaining the desired sub-categories in the category fields of the media file; and
obtaining the sub-category weight values of the desired sub-categories from the corresponding category tables.

3. The method for generating a play-list according to claim 2, wherein the step of calculating a final weight value of the media file further comprises:
aggregating the obtained sub-category weight values of the desired sub-categories to obtain the final weight value thereof.

4. The method for generating a play-list according to claim 2, wherein the step of calculating a final weight value of the media file further comprises:
assigns a weight value to each sub-category weight value in the updated category tables, obtains the sub-category weight values corresponding to the desired sub-categories each media file has from the updated category tables, multiplies each sub-category weight value by the corresponding weight value assigned therewith, and sums the multiplied sub-category weight values to obtain the final weight value of the media file.

5. The method for generating a play-list according to claim 1, wherein the predetermined initial value is zero.

6. The method for generating a play-list according to claim 1, wherein the step of generating the play-list of the media files further comprises:
rearranging all the media files according to the final weight values thereof, thereby generating the play-list therefrom.

7. The method for generating a play-list according to claim 1, wherein the step of generating the play-list of the media files further comprises:
selecting one or more media files each of which has a final weight value being greater than a predetermined value, thereby generating the play-list therefrom.

8. The method for generating a play-list according to claim 1, wherein the step of generating the play-list of the media files further comprises:
rearranging all the media files based on the final weight values in descending order, selecting a predetermined amount of media files on the top of the ordered list, thereby generating another play-list therefrom.

9. A system for generating a play-list of media files, each of the media files comprising a tag for holding a plurality of fields thereupon, the system comprising:
a data storage unit, for storing the media files and a plurality of category tables, wherein the tag of each media file comprises a weight field for storing a weight value thereof, and a plurality of category fields each storing a plurality of desired sub-categories corresponding to the media file, each of the category table storing a desired sub-category and corresponding sub-category weight values;
an input unit for generating commands in response to operations of a user;
a control unit for identifying the commands and performing corresponding control commands, wherein the control commands comprise a play-list generation control command; and
a file management unit, under the control of the control unit, for rearranging the media files based on the weight values in the weight fields of each media file in descending order; resetting sub-category weight values associated with the desired sub-category in the category tables to a predetermined initial value; obtaining a predetermined amount of media files on the top of the ordered list; reading desired sub-categories and weight values in the category fields of the obtained media files; incrementing a corresponding sub-category weight value in the corresponding initialized category tables by the weight values of the obtained media files; calculating final weight values of each media file according to the category tables; and generating the play-list of the media files according to the final weight values thereof.

10. The system for generating a play-list according to claim 9, wherein the file management unit further obtains the desired sub-categories in the category fields of the media file; and obtains the sub-category weight values of the desired sub-categories from the corresponding category tables.

11. The system for generating a play-list according to claim 10, wherein the file management unit further aggregates the obtained sub-category weight values of the desired sub-categories to obtain the final weight value thereof.

12. The system for generating a play-list according to claim 10, wherein the file management unit further assigns a weight value to each sub-category weight value in the updated category tables, obtains the sub-category weight values corresponding to the desired sub-categories each media file has from the updated category tables, multiplies each sub-category weight value by the corresponding weight value assigned therewith, and sums the multiplied sub-category weight values to obtain the final weight value of the media file.

13. The system for generating a play-list according to claim 9, wherein the predetermined initial value is zero.

14. The system for generating a play-list according to claim 9, wherein the file management unit further rearranges all the media files according to the final weight values thereof, thereby generating the play-list therefrom.

15. The system for generating a play-list according to claim 9, wherein the file management unit further selects one or more media files each of which has a final weight value being greater than a predetermined value, thereby generating the play-list therefrom.

16. The system for generating a play-list according to claim 9, wherein the file management unit further rearranges all the media files based on the final weight values in descending order, selects a predetermined amount of media files on the top of the ordered list, thereby generates another play-list therefrom.
